(19) United States
(12) Patent Application Publication
(10) Pub. No.: US 2011/0195877 A1
(43) Pub. Date: Aug. 11, 2011

(54) CRYSTALLINE CERAMIC PARTICLES

(76) Inventor: Thomas J. Adderson, Cottage Grove, MN (US)

(21) Appl. No.: 13/123,635

(22) PCT Filed: Oct. 26, 2009
(86) PCT No.: PCT/US2009/062073

§ 371 Date: Apr. 11, 2011

Related U.S. Application Data
(60) Provisional application No. 61/109,749, filed on Oct. 30, 2008.

(51) Int. Cl. C09K 8/80

(52) U.S. Cl. 507/269

(57) ABSTRACT

Crystalline ceramic particles including at least 90 percent by weight Al₂O₃, based on the total weight of the crystalline ceramic particle, and having a density in a range from 50 to 75 percent of theoretical density, a long term flow conductivity of at least 4.5×10⁻¹² m²-m at 55.2 MPa, and a smallest dimension of at least 100 micrometers. The crystalline ceramic particles described herein are useful for example, as proppants, insulation (thermal and/or sound), and filler.

### BACKGROUND

Hydraulic fracturing is a process of injecting fluids into an oil or gas bearing formation at sufficiently high rates and pressures such that the formation fails in tension and fractures to accept the fluid. In order to hold the fracture open once the fracturing pressure is released, a propping agent (i.e., a proppant) is mixed with the fluid and injected into the formation. Generally hydraulic fracturing increases the flow of oil or gas from a reservoir to the well bore in at least three ways: (1) the overall reservoir area connected to the well bore is increased, (2) the proppant in the fracture has significantly higher permeability than the formation itself, and (3) the highly conductive (propped) channels create a large pressure gradient in the reservoir past the tip of the fracture.

Proppants are preferably spherical particulates that resist high temperatures, pressures, and the corrosive environment present in the formation. If proppants fail to withstand the closure stresses of the formation, they disintegrate, producing fines or fragments, which reduce the permeability of the propped fracture. Early proppants were based on silica sand, glass beads, sand, walnut shells, or aluminum pellets. For its sensible balance of cost and compressive strength, silica sand (frac-sand) is still widely used proppant in the fracturing business. Its use, however, is limited to closure stresses of 6,000 psi (41.4 MPa). Beyond this depth resin-coated and ceramic proppants are used. Resin-coated and ceramic proppants are generally limited to closure stresses of 8,000 psi (55.2 MPa) and 12,000 psi (82.8 MPa), respectively.

Of a study for the U.S. Department of Energy, published in April 1982 (Cutler and Jones, “Lightweight Proppants for Deep Gas Well Stimulation” DOE/BC/10038-22), ideal proppants for hydraulic fracturing would have a specific gravity less than 2.0 g/cm³, be able to withstand closure stresses of 138 MPa, be chemically inert in brine at temperatures to 200° C., have perfect sphericity, cost the same as sand on a volume basis, and have a narrow proppant size distribution. The report concludes that such a proppant is not likely to be forthcoming in the foreseeable future.

### SUMMARY

In one aspect, the present disclosure provides a crystalline ceramic particle comprising at least 90 percent by weight Al₂O₃, based on the total weight of the crystalline ceramic particle, and having a density in a range from 50 to 75 percent of theoretical density, a Long Term Flow Conductivity of at least 15,000 md-ft (4.5×10⁻¹² m²-m) at 8000 psi (55.2 MPa), and a smallest dimension of at least 100 micrometers. The “Long Term Flow Conductivity” is determined as described in the Examples, below.

Crystalline ceramic particles described herein are useful, for example, as proppants, insulation (thermal and/or sound), and filler. For example, crystalline ceramic particles described herein are useful in a method of propping open fractures in the walls of a bored well, comprising:

introducing into the well a fluid mixture of carrier fluid and a plurality of the spherical crystalline ceramic particles described herein; and

depositing the plurality of spherical crystalline ceramic particles in the fractures to yield at least one propped channel. Techniques for fracturing subterranean geological formation comprising hydrocarbons are known in the art, as are techniques for injecting proppants into the fractured formation to prop open fracture openings. In some methods, a hydraulic fluid is injected into the subterranean geological formation at rates and pressures sufficient to open a fracture therein. The fracturing fluid (usually water with specialty high viscosity fluid additives) when injected at the high pressures exceeds the rock strength and opens a fracture in the rock. Proppant particles described herein can be included in the fracturing fluid.

### DETAILED DESCRIPTION

Crystalline ceramic particles described herein can generally be made by a variety of methods including converting porous ceramic particles into crystalline ceramic particles described herein. Typically the porous ceramic has interconnected internal pores (i.e., pores which are located in the interior of a body and which are connected either directly or through adjoining pores to the surface such that a continuous path exists between the pore and the surface). Suitable porous particles for making crystalline ceramic particles described herein can be made of various techniques known in the art, and/or selected from commercially available sources (e.g., alumina spheres having continuous porosity of about 80 percent by volume, available from Sasol, Germany), for example, sol-gel process such as reported in U.S. Pat. No. 4,314,827 (Leitheiser et al.), U.S. Pat. No. 4,518,397 (Leitheiser et al.), U.S. Pat. No. 4,744,802 (Schwabel), U.S. Pat. No. 4,770,671 (Monroe et al.), U.S. Pat. No. 4,881,951 (Wood et al.), U.S. Pat. No. 4,954,462 (Wood et al.), U.S. Pat. No. 4,964,883 (Morris et al.), U.S. Pat. No. 5,593,467 (Monroe), and U.S. Pat. No. 5,645,618 (Monroe et al.).

Typically, the crystalline ceramic particles comprise at least one oxide other than Al₂O₃ (e.g., Ce₂O₃, CoO, Cr₂O₃, Dy₂O₃, Er₂O₃, Eu₂O₃, Fe₂O₃, Gd₂O₃, HfO₂, La₂O₃, Li₂O, MgO, MnO, Nd₂O₃, NiO, Pr₂O₃, Sm₂O₃, TiO₂, Y₂O₃, Yb₂O₃, ZnO, and/or ZrO₂), wherein the amount of any individual amount of the oxide other than Al₂O₃ may be at least 0.1, 0.2, 0.5, 0.75, 1, 2, 3, 4, 5, 6, 7, 8, 9, or even 10 percent by weight, based on the total weight of the crystalline ceramic particles. In another aspect, the collective amount of oxide other than Al₂O₃ may be at least 0.1, 0.2, 0.5, 0.75, 1, 2, 3, 4, 5, 6, 7, 8, 9, or even 10 percent by weight, based on the total weight of the crystalline ceramic particles.

The oxide other than Al₂O₃ (or precursor thereof) may be added in whole or part when a porous ceramic particle is made. If the oxide other than Al₂O₃ (or precursor thereof) is added to porous ceramic particles, it is typically added via an impregnation composition (i.e., a solution and/or dispersion comprising a liquid precursor (e.g., water) and oxide(s) and/or precursor(s) thereof (e.g., nitrates, acetates, chlorides, etc.)).

Porous ceramic particles for making crystalline ceramic particles described herein can be made, for example, via sol gel processes known in the art, including those where a hydrated form of alumina (i.e., alpha alumina monohydrate or boehmite (typically alpha alumina monohydrate and boehmite commonly referred to in the art as “pseudo” boehmite (i.e., Al₂O₃.xH₂O, wherein x=1 to 2)) is mixed with water and peptizing agent to produce a colloidal dispersion or sol. The colloidal dispersion of boehmite is deliquified to form precursor, which is typically calcined to provide porous ceramic. During the calcining, boehmite converts to transitional alumina(s). In some embodiments, the porous ceramic is impregnated with a solution and/or dispersion comprising a liquid precursor (e.g., water) and oxide(s) and/or precursor(s) thereof (e.g., nitrates, acetates, chlorides, formates, etc.). Impregnated ceramic is typically dried and calcined again.

The calcined particles are sintered to provide the crystalline ceramic particles described herein. During sintering, the transitional alumina(s) is transformed to alpha alumina, and densified.

Typically, a (boehmite) dispersion is made by combining or mixing components comprising liquid medium, peptizing agent, at least 35 percent by weight boehmite, and optionally metal oxide(s) and/or precursors thereof. The liquid medium is typically water (preferably deionized water), although organic solvents, such as lower alcohols (typically C₁₋₆ alcohols), hexane, or heptane, may also be useful as the liquid medium. In some instances, it is preferable to heat the liquid medium (e.g., 60-70° C.) to improve the dispersibility of the boehmite.

Typically, the (boehmite) dispersion comprises at least about 20% by weight (generally from about 20% to about 70% by weight) liquid medium, based on the total weight of the dispersion. In another aspect, the dispersion typically comprises greater than 35% by weight (generally from greater than 35% to about 80% by weight) solids, based on the total weight of the dispersion.

Weight percents of solids and boehmite above about 80 wt-% may also be useful, but tend to be more difficult to process to make the crystalline ceramic particles described herein.

Suitable boehmite can be prepared using various techniques known in the art (see, e.g., U.S. Pat. No. 4,202,870 (Weber et al.) and U.S. Pat. No. 4,676,928 (Leach et al.), the disclosures of which are incorporated herein by reference). Suitable boehmite can also be obtained, for example, from commercial sources such as SASOL, GmbH, Hamburg, Germany (e.g., under the trade designation “DISPERAL” “DISPAL”, “CATAPAL A,” “CATAPAL B,” and “CATAPAL D”). These aluminum oxide monohydrates are in the alpha form, and include relatively little, if any, hydrated phases other than monohydrates (although very small amounts of trihydrate impurities can be present in some commercial grade boehmite, which can be tolerated). They typically have a low solubility in water, and have a high surface area (typically at least about 180 m²/g). Boehmite typically includes at least about 2-6 percent by weight free water (depending on the humidity) on its surface, and such water contributes to the amount of liquid medium in the dispersion.

Typically, the boehmite has an average ultimate particle size of less than about 20 nanometers (more preferably, less than about 12 nanometers), wherein “particle size” is defined by the longest dimension of a particle.

Peptizing agents are generally soluble ionic compounds which are believed to cause the surface of a particle or colloid to be uniformly charged in the liquid medium. Such charged particles generally repel each other, resulting in the formation of stable, non-floculated suspensions or sols.

Acids, which are believed to function as a peptizing agent, also referred to as a dispersant, include monoprotic acids and acid compounds (e.g., acetic, hydrochloric, formic, and nitric acid). Nitric acid is often a preferred peptizing agent. Some commercial sources of boehmite may contain acid titer, such as absorbed formic or nitric acid on the surface thereof. The amount of acid used depends, for example, on the dispersibility of the boehmite, the percent solids of the dispersion, the components of the dispersion, the amounts, or relative amounts of the components of the dispersion, the particle sizes of the components of the dispersion, and/or the particle size distribution of the components of the dispersion. Typically, the dispersion contains at least 3% to 8% by weight acid, based on the weight of boehmite in the dispersion.

Optionally, the dispersion contains metal oxide(s) (e.g., particles of metal oxide which may have been added as a particulate (preferably having a particle size (i.e., the longest dimension) of less than about 5 micrometers; more preferably, less than about 1 micrometer) and/or added as a metal oxide sol (including colloidal metal oxide sol)) and/or metal oxide precursor (e.g., a salt such as a metal nitrate, a metal acetate, a metal citrate, a metal formate, or a metal chloride that converts to a metal oxide(s) upon decomposition by heating). The amount of such metal oxide and/or metal oxide precursor (that is in addition to the alumina provided by the boehmite) present in a dispersion or precursor (or metal oxide in the case of the abrasive grain) may vary depending, for example, on which metal oxide(s) is present and the properties desired for the crystalline ceramic particles.

Metal oxide precursors include metal nitrate salts, metal acetate salts, metal citrate salts, metal formate salts, and metal chloride salts. Examples of nitrate salts include magnesium nitrate (Mg(NO₃)₂.6H₂O), cobalt nitrate (Co(NO₃)₂.6H₂), nickel nitrate (Ni(NO₃)₂.6H₂O), lithium nitrate (LiNO₃), manganese nitrate (MN(NO₃)₂.4H₂O), chromium nitrate (Cr(NO₃)₃.9H₂O), yttrium nitrate (Y(NO₃)₃.6H₂O), praseodymium nitrate (Pr(NO₃)₃.6H₂O), samarium nitrate (Sm(NO₃)₃.6H₂O), neodymium nitrate (Nd(NO₃)₃.6H₂O), lanthanum nitrate (La(NO₃)₃.6H₂O), gadolinium nitrate (Gd (NO₃)₃.5H₂O), dysprosium nitrate (Dy(NO₃)₃.5H₂O), europium nitrate (Eu(NO₃)₃.6H₂O), ferric nitrate (Fe(NO₃)₃.9H₂O), zinc nitrate (Zn(NO₃)₃.6H₂O), erbium nitrate (Er(NO₃)₃.5H₂O), and zirconium nitrate (Zr(NO₃)₄.5H₂O). Examples of metal acetate salts include zirconyl acetate (ZrO(CH₃COO)₂), magnesium acetate, cobalt acetate, nickel acetate, lithium acetate, manganese acetate, chromium acetate, yttrium acetate, praseodymium acetate, samarium acetate, ytterbium acetate, neodymium acetate, lanthanum acetate, gadolinium acetate, and dysprosium acetate. Examples of citrate salts include magnesium citrate, cobalt citrate, lithium citrate, and manganese citrate. Examples of formate salts include magnesium formate, cobalt formate, lithium formate, manganese formate, and nickel formate.

Optional forms of metal oxide additives to dispersions include colloidal metal oxides and precursors thereof. Precursors of colloidal metal oxide include a water-dispersible or water-soluble metal source that forms finely divided (1 nanometer to 1 micrometer) polymers or particles of metal oxide upon heating.

The colloidal metal oxides are discrete finely divided particles of amorphous or crystalline metal oxide having one or more of their dimensions within a range of about 3 nanometers to about 1 micrometer. Colloidal metal oxides include sols of ceria, silica, yttria, titania, lanthana, neodymia, zirconia, and mixtures thereof. Metal oxide sols are available, for example, from Nalco, Naperville, Ill.; and Eka Nobel, Augusta, Ga. Silica sols include those available under the trade designations “NALCO 1115,” “NALCO 1130,” “NALCO 2326,” NALCO 1034A,” and NALCOAG 1056” from Nalco Products, Inc., Naperville, Ill., wherein the latter two are examples of acidic silica sols; and “NYACOL 215” from Eka Nobel, Inc. Ceria sols are available, for example, from Rhone-Ploulenc, Shelton, Conn.; Transelco, Pa. Yan, N.Y.; and Fujimi Corp., Japan.

Whether from colloidal metal oxide directly, or from other forms or sources of colloidal metal oxide, the average metal oxide particle size in the colloidal metal oxide is preferably less than about 150 nanometers, more preferably less than about 100 nanometers, and most preferably less than about 50 nanometers. In some instances, the metal oxide particles can be on the order of about 3-10 nanometers. In most instances, the colloidal metal oxide comprises a distribution or range of metal oxide particle sizes.

Typically, the use of a metal oxide modifier can decrease the porosity of the sintered crystalline ceramic particles, and thereby increase the density. Certain metal oxides may react with the alumina to form a reaction product and/or form crystalline phases with the alpha alumina For example, the oxides of cobalt, nickel, zinc, and magnesium typically react with alumina to form a spinel, whereas zirconia and hafnia do not react with the alumina. Alternatively, for example, the reaction products of dysprosium oxide and gadolinium oxide with aluminum oxide are generally garnet. The reaction products of praseodymium oxide, ytterbium oxide, erbium oxide, and samarium oxide with aluminum oxide generally have a perovskite and/or garnet structure. Yttria can also react with the alumina to form Y₃Al₅O₁₂ having a garnet crystal structure. Certain rare earth oxides and divalent metal cations react with alumina to form a rare earth aluminate represented by the formula LnMAl₁₁O₁₉, wherein Ln is a trivalent metal ion such as La³⁺, Nd³⁺, Ce³⁺, Pr³⁺, Sm³⁺, Gd³⁺, Er³⁺, or Eu³⁺, and M is a divalent metal cation such as Mg²⁺, Mn²⁺, Ni²⁺, Zn²⁺, or Co²⁺. Such aluminates have a hexagonal crystal structure.

Optionally, the dispersion contains nucleating material (e.g., alpha alumina, alpha iron oxide, and/or an alpha iron oxide precursor). “Nucleating material” refers to material that enhances the transformation of transitional alumina(s) to alpha alumina via extrinsic nucleation. The nucleating material can be a nucleating agent (i.e., material having the same or approximately the same crystalline structure as alpha alumina, or otherwise behaving as alpha alumina) itself (e.g., alpha alumina seeds, alpha Fe₂O₃ seeds, or alpha Cr₂O₃ seeds) or a precursor thereof.

Typically, nucleating material, if present, comprises, on a theoretical metal oxide basis (based on the total metal oxide content of the calcined material before sintering (or the sintered abrasive grain)), in the range from about 0.1 to about 5 percent by weight.

Sources of iron oxide, which in some cases may act as or provide a material that acts as a nucleating agent, include hematite (i.e., .alpha.-Fe₂O₃), as well as precursors thereof (i.e., goethite (alpha-FeOOH), lepidocrocite (gamma-FeOOH), magnetite (Fe₃O₄), and maghemite (gamma-Fe₂O₃)). Suitable precursors of iron oxide include iron-containing material that, when heated, will convert to alpha-Fe₂O₃.

Iron oxide sources can be prepared by a variety of techniques well known in the art. For example, a dispersion of hematite (alpha-Fe₂O₃) can be prepared by the thermal treatment of iron nitrate solutions, as is described, for example, by E. Matijevic et al., J. Colloidal Interface Science, 63, 509-24 (1978), and B. Voight et al., Crystal Research Technology, 21, 1177-83 (1986), the teachings of which are incorporated herein by reference. Lepidocrocite (gamma.-FeOOH) can be prepared, for example, by the oxidation of Fe(OH)₂ with a NaNO₂ solution. Maghemite (gamma-Fe₂O₃) can be obtained, for example, by dehydrating gamma-FeOOH in a vacuum. Gamma-FeOOH can also be converted to alpha-Fe₂O₃, for example, by heating or grinding gamma.-FeOOH in air. Goethite (alpha-FeOOH) can be synthesized, for example, by air oxidation of ferrous hydroxide or by aging a dispersion of ferric hydroxide at an elevated temperature and high pH. Additional information on the preparation of oxides of iron can be found, for example, in the articles by R. N. Sylva, Rev. Pure Applied Chemistry, 22, 15 (1972), and T. Misawa et al., Corrosion Science, 14 131 (1974), the teachings of which are incorporated herein by reference.

A (boehmite) dispersion can be prepared, for example, by gradually adding a liquid component(s) to a component(s) that is non-soluble in the liquid component(s), while the latter is mixing or tumbling. For example, a liquid containing water, nitric acid, and metal salt can be gradually added to boehmite, while the latter is being tumbled such that the liquid is more easily distributed throughout the boehmite Suitable mixers include pail mixers (available, for example, from Sears Roebuck and Co.), sigma blade mixers (available, for example, from Paul 0. Abbe, Inc., Little Falls, N.J.), and high shear mixers (available, for example, from Charles Ross & Son Co., Hauppauge, N.Y.). Other suitable mixers may be available from Eirich Machines, Inc., Gurnee, Ill.; Hosokawa-Bepex Corp., Minneapolis, Minn. (including a mixer available under the trade designation “SCHUGI FLEX-O-MIX”, Model FX-160); and Littleford-Day, Inc., Florence, Ky. Other suitable preparation techniques may be apparent to those skilled in the art after reviewing the disclosure herein.

The dispersion typically gels prior to or during the deliquifying step. The addition of most modifiers can result in the dispersion gelling faster.

In general, techniques for deliquifying (including drying) the dispersion are known in the art, including heating to promote evaporation of the liquid medium, or simply drying in air. The deliquifying step generally removes a significant portion of the liquid medium from the dispersion; however, there still may be a minor portion (e.g., about 10% or less by weight) of the liquid medium present in the dried dispersion.

Typically, it is desirable for the crystalline ceramic particles to be spherical. To provide the desired shape which facilitates the crystalline ceramic particles having a Long Term Flow Conductivity of at least 20,000 md-ft (6×10⁻¹² m²-m) at 8000 psi (55.2 MPa) (in some embodiments, in a range from 15,000 to 20,000 md-ft (4.5×10⁻¹² to 6×10⁻¹² m²-m)) at 8000 psi (55.2 MPa)), the dispersion can be shaped by dispersing into droplets in a particle forming liquid such as reported in U.S. Pat. No. 4,837,069 (Bescup et al.), by utilizing a patterned surface to mold the dispersion as reported in U.S. Pat. No. 5,984,988 (Berg et al.), or by extruding the dispersion through shaped dies. It may be preferable to extrude (typically a dispersion where at least 50 percent by weight of the alumina content is provided by particulate (e.g., boehmite), including in this context a gelled dispersion, or even partially deliquified dispersion. The extruded dispersion, referred to as extrudate, can be extruded into elongated precursor material (e.g., rods (including cylindrical rods and elliptical rods)). Examples of suitable extruders include ram extruders, single screw, twin screw, and segmented screw extruders. Suitable extruders are available, for example, from Loomis Products, Levitown, Pa., Bonnot Co., Uniontown, Ohio, and Hosokawa-Bepex of Minneapolis, Minn., which offers, for example, an extruder under the trade designation “EXTRUD-O-MIX” (Model EM-6).

In some embodiments, crystalline ceramic particles described herein have, for example, a Krumbein-Sloss Sphericity Number in a range from 0.8 to 1, 0.85 to 1, 0.9 to 1, or even 0.95 to 1; and/or a Krumbein-Sloss Roundness Number in a range from 0.8 to 0.1, 0.85 to 1, 0.9 to 1, or even 0.95 to 1. The “Krumbein-Sloss Sphericity Number” and “Krumbein-Sloss Roundness Number” can be determined as described in ARI RP 60, Second Edition, December 1995, Section 6, entitled “Recommended Proppant Sphericity and Roundness,” the disclosure of which is incorporated herein by reference.

In general, techniques for calcining the deliquified dispersion or dried dispersion, wherein essentially all the volatiles are removed, and the various components that were present in the dispersion are transformed into oxides, are known in the art. Such techniques include using a rotary or static furnace to heat deliquified dispersion at temperatures ranging from about 400-1000° C. (typically from about 450-800° C.) until the free water, and typically until at least about 90 wt-% of any bound volatiles are removed. In some instances, it may be preferable to slowly heat the deliquified dispersion to the calcining temperature (e.g., heating the deliquified dispersion to 750° C. over a 6 hour period.

Preferred calcining temperatures are typically not greater than 900° C. (more typically in the range from about 450° C. to about 800° C. (more preferably, about 600° C. to about 700° C.). It may, however, be desirable to utilize several different calcining conditions (including different temperatures) wherein, for example, the deliquified dispersion is partially calcined for a time at a temperature(s) below about 500° C., and then further calcined at a temperature(s) above about 600° C. Heating for the calcining step, which can be done, for example, using electrical resistance or gas, can be on a batch basis or on a continuous basis.

In some embodiments, the porous ceramic particles are impregnated with an impregnation composition that includes metal oxides and/or precursors thereof (including nucleating materials) as described above for the making the dispersion. For example, a porous ceramic material typically has pores about 5-10 nanometers in diameter extending therein from an outer surface. The presence of such pores allows an impregnation composition comprising a mixture comprising liquid medium and optional appropriate metal oxide and/or precursor (preferably metal salts such as the metal nitrate, acetate, citrate, and formate salts described above with regard to preparation of a dispersion) to enter into, or in the case of particulate material on the surface of, porous ceramic particles. It is also within the scope of the present disclosure to impregnate with an aluminum salt, although typically the impregnate is a salt other than an aluminum salt. The metal salt material is dissolved in a liquid, and the resulting solution mixed with the porous ceramic particles. Although not wanting to be bound by theory, it is believed the impregnation process is thought to occur through capillary action.

The liquid used for the impregnating composition is preferably water (including deionized water), an organic solvent (preferably a non-polar solvent), and mixtures thereof.

If impregnation of a metal salt is desired, the concentration of the metal salt in the liquid medium is typically in the range from about 5% to about 40% dissolved solids, on a theoretical metal oxide basis. Preferably, there is at least 50 ml of solution added to achieve impregnation of 100 grams of porous ceramic particles, more preferably, at least about 60 ml of solution to 100 grams of porous ceramic particles.

In some instances, more than one impregnation step may be utilized. The same impregnation composition may be applied in repeated treatments, or subsequent impregnation compositions may contain different concentrations of the same salts, different salts, or different combinations of salts. Further, it is within the scope of the present disclosure to, for example, first impregnate the porous ceramic particles with an impregnation composition comprising a mixture comprising liquid (e.g., water) and an acidic metal salt, and then further impregnate with a second impregnation composition comprising a mixture comprising liquid (e.g., water) and a base or basic salt (e.g., NH₄OH). Although not wanting to be bound by theory, it is believed that the second impregnation of the base or basic salt causes the impregnated acidic metal oxide precursor(s) to precipitate thereby reducing migration of the porous ceramic particles.

In another aspect, the impregnation composition may be comprised of a mixture comprising liquid, an acidic metal salt and a base precursor (e.g., urea or formamide, acetamide, hydroxlamine, and methylamin), wherein the latter decomposes on heating to yield a base. Again, although not wanting to be bound by theory, it is believed that the base causes the impregnated acidic metal salt to precipitate thereby reducing migration of the metal oxide precursors.

During heat treatment of the impregnated particles to form the sintered, alpha alumina-based ceramic particles, metal oxide and/or precursor thereof in such particles may react with alumina to form a reaction product. For example, the oxides of cobalt, nickel, zinc, and magnesium typically react with alumina to form a spinel structure. Yttria typically reacts with alumina to form 3Y₂O₃.3.5Al₂O₃, which has the garnet crystal structure. Praseodymium, samarium, ytterbium, neodymium, lanthanum, gadolinium, cerium, dysprosium, erbium, and mixtures of two or more of these rare earth metals typically react with alumina to form garnet, beta alumina, or phases exhibiting a perovskite structure. Certain rare earth oxides and divalent metal oxides react with alumina to form a rare earth aluminate represented by the formula LnMAl₁₁O₁₉, wherein Ln is a trivalent metal ion such as La, Nd, Ce, Pr, Sm, Gd, or Eu, and M is a divalent metal cation such as Mg, Mn, Ni, Zn, Fe, or Co. Such rare earth aluminates typically have a hexagonal crystal structure that is sometimes referred to as a magnetoplumbite crystal structure. Hexagonal rare earth aluminates generally have exceptional properties in an abrasive particle and if present, are typically within the abrasive particle as a whisker(s) or platelet(s). Such whiskers or platelets typically have a length of about 0.5 micrometer to about 1 micrometer, and a thickness of about 0.1 micrometer or less. These whiskers or platelets are more likely to occur in the absence of a nucleating agent.

In general, techniques for sintering the calcined material, which include heating at a temperature effective to transform transitional alumina(s) into alpha alumina, to causing all of the metal oxide precursors to either react with the alumina or form metal oxide, and increasing the density of the ceramic material, are known in the art. As used herein, transitional alumina is any crystallographic form of alumina that exists after heating the hydrated alumina to remove the water of hydration prior to transformation to alpha alumina (e.g., eta, theta, delta, chi, iota, kappa, and gamma forms of alumina and intermediate combinations of such forms). The calcined material can be sintered, for example, by heating (e.g., using electrical resistance, microwave, plasma, laser, or gas combustion, on batch basis (e.g., using a static furnace) or a continuous basis (e.g., using a rotary kiln)) at temperatures ranging from about 1200° C. to about 1650° C. (typically, from about 1200° C. to about 1550° C., more typically, from about 1300° C. to about 1450° C., or even from about 1350° C. to about 1450° C.). The length of time which the calcined material is exposed to the sintering temperature depends, for example, on particle size, composition of the particles, and sintering temperature. Typically, sintering times range from a few seconds to about 60 minutes (preferably, within about 3-30 minutes). Sintering is typically accomplished in an oxidizing atmosphere, although neutral (e.g., argon or nitrogen) or reducing atmospheres (e.g., hydrogen or forming gas) may also be useful.

One skilled in the art, after reviewing the disclosure herein, may be able to select other techniques for sintering the calcined material, as well as select appropriate conditions such as sintering temperature(s), sintering time(s), sintering rate(s), (including the heating and/or cooling rate(s)), environment(s) (including relative humidity, pressure (i.e., atmospheric pressure or a pressure above or below the atmospheric pressure), and/or the component(s) making up the sintering atmosphere), other than those specifically provided herein. The more suitable sintering conditions may depend, for example, on one or more of the following: the particular dispersion (e.g., the percent solids of the dispersion, the components of the dispersion, the amounts, or relative amounts of the components of the dispersion, the particle sizes of the components of the dispersion, and/or the particle size distribution of the components of the dispersion), the sintering temperature(s), the sintering time(s), the sintering rates(s), and the component(s) making up the sintering atmosphere).

It may, however, be desirable to utilize several different sintering conditions (including different temperatures) wherein, for example, the calcined ceramic particles are partially sintered for a time at a temperature(s) below 1200° C., and then further sintered at a temperature(s) above 1350° C.

In some embodiments, crystalline ceramic particles described herein can comprise, for example, at least 92, 93, 94, 95, 96, 97, 98, or even 99 percent by weight of the Al₂O₃, based on the total weight of the crystalline ceramic particle, wherein, for example, at least 50 (in some embodiments, at least 55, 60, 65, 70, 75, 80, 85, 90, 92, 93, 94, 95, 96, 97, 98, 99, or even 100) percent by weight of the Al₂O₃ is present as alpha alumina.

In some embodiments, crystalline ceramic particles described herein further comprise, for example, at least one of MgO, rare earth oxide or Y₂O₃, ZrO₂, SiO₂, TiO₂, CeO₂ (in some embodiments, in a range from 1 to 10 percent by weight of rare earth oxide and or Y₂O₃; and or in a range from 1 to 10 MgO, based on the total weight of the spherical crystalline ceramic particle. In some embodiments, crystalline ceramic particles described herein further comprise, for example, at least one rare earth aluminate exhibiting a magnetoplumbite crystal structure.

In some embodiments, the density of crystalline ceramic particles described herein can be, for example, in a range from 40 to 75 (in some embodiments, in a ranger from 40 to 70, or even 40 to 65) percent of theoretical density. In some embodiments, crystalline ceramic particles described herein have an inner region and an outer region, wherein the outer region has a higher density than the inner region (e.g., at least 5, or even at least 10 percent higher).

In some embodiments, crystalline ceramic particles described herein have a Crush Strength Value of at least 12,500 psi (86.2 MPa) (in some embodiments, in a range from 12,500 psi (86.2 MPa) to 15,000 psi (103.4 MPa)). The “Crush Strength Value” is determined as described in the Examples, below.

In some embodiments, crystalline ceramic particles described herein have an Acid Solubility Loss of no greater than 2 percent by weight (in some embodiments, no greater than 1.5, 1, or even no greater than 0.5 percent by weight). The “Acid Solubility Loss” is determined as described in the Examples, below.

In some embodiments, crystalline ceramic particles described herein have a coating thereon (e.g., a resin (e.g., a thermoplastic or thermoset resin)). Exemplary resins include those selected from the group consisting of polyolefin homo- and copolymers; styrene copolymers and terpolymers; ionomers; ethyl vinyl acetate homo- and copolymers; polyvinylbutyrate homo- and copolymers; polyvinyl chloride homo- and copolymers; metallocene polyolefins; poly(alpha olefins) homo- and copolymers; ethylene-propylene-diene terpolymers; fluorocarbon elastomers; polyester polymers and copolymers; polyamide polymers and copolymers, polyurethane polymers and copolymers; polycarbonate polymers and copolymers; polyketones; and polyureas; and blends thereof. Exemplary resins also include those selected from the group consisting of epoxy resins, acrylated urethane resins, acrylated epoxy resins, ethylenically unsaturated resins, aminoplast resins, isocyanurate resins, phenolic resins, vinyl ester resins, vinyl ether resins, urethane resins, cashew nut shell resins, napthalinic phenolic resins, epoxy modified phenolic resins, silicone resins, polyimide resins, urea formaldehyde resins, methylene dianiline resins, methylpyrrolidinone resins, acrylate and methacrylate resins, isocyanate resins, unsaturated polyester resins, and blends thereof.

In some embodiments, the coating includes glass bubbles. Typically, the proppants coated with glass bubbles have a specific gravity less than the proppants While not wanting to be bound by theory, it is believed lower density proppants improve the ease of handling by reducing the pumping pressures needed to maintain proppant transport through the fracture.

In some embodiments, crystalline ceramic particles described herein, the smallest dimension is at least 100 micrometers; in some embodiments, in a range from 100 micrometers to 3000 micrometers (in some embodiments, 200 micrometers to 2000 micrometers).

In some embodiments, crystalline ceramic particles described herein at least 90 (in some embodiments, at least 91, 92, 93, 94, 95, 96, 97, 98, 99, or even 100; in some embodiments, in a range from 90 to 100) percent by volume have a smallest dimension of at least 100 micrometers (in some embodiments, at least 200 micrometers). In some embodiments, crystalline ceramic particles described herein have at least 90 (in some embodiments, at least 91, 92, 93, 94, 95, 96, 97, 98, 99, or even 100; in some embodiments, in a range from 90 to 100) percent by volume of the crystalline ceramic particles have an average diameter within 15% (in some embodiments, within 10%) of the median diameter of the crystalline ceramic particles.

Crystalline ceramic particles described herein are useful for example, as proppants, insulation (thermal and/or sound), and filler. For example, crystalline ceramic particles described herein may be used in wells in which fractures are produced using any means that yields desired fractures in the underground rock formations (e.g., hydrofracturing (sometimes referred to as “hydrofraccing”)) and etching (such as acid etching).

The main functions of a fracturing fluid are to initiate and propagate fractures and to transport a proppant to hold the walls of the fracture apart after the pumping has stopped and the fracturing fluid has leaked off or flowed back. Many known fracturing fluids comprise a water-based carrier fluid, a viscosifying agent, and the proppant. The viscosifying agent is often a cross-linked water-soluble polymer. As the polymer undergoes hydration and crosslinking, the viscosity of the fluid increases and allows the fluid to initiate the fracture and to carry the proppant. Another class of viscosifying agent is viscoelastic surfactants (“VES's”). Both classes of fracturing fluids (water with polymer, and water with VES) can be pumped as foams or as neat fluids (i.e., fluids having no gas dispersed in the liquid phase). Foamed fracturing fluids typically contain nitrogen, carbon dioxide, or mixtures thereof at volume fractions ranging from 10% to 90% of the total fracturing fluid volume. The term “fracturing fluid,” as used herein, refers to both foamed fluids and neat fluids. Non-aqueous fracturing fluids may be used as well.

The carrier fluid that is used to deposit the proppant particles in the fracture may be the same fluid that is used in the fracturing operation or may be a second fluid that is introduced into the well after the fracturing fluid is introduced. As used herein, the term “introducing” (and its variants “introduced”, etc.) includes pumping, injecting, pouring, releasing, displacing, spotting, circulating, or otherwise placing a fluid or material (e.g., proppant particles) within a well, wellbore, fracture or subterranean formation using any suitable manner known in the art.

A variety of aqueous and non-aqueous carrier fluids can be used. Exemplary water based fluids and brines which are suitable for use with the crystalline ceramic particles described herein include fresh water, sea water, sodium chloride brines, calcium chloride brines, potassium chloride brines, sodium bromide brines, calcium bromide brines, potassium bromide brines, zinc bromide brines, ammonium chloride brines, tetramethyl ammonium chloride brines, sodium formate brines, potassium formate brines, cesium formate brines, and any combination thereof.

Exemplary water based polymer and polymer-containing treatment fluids suitable for use with the crystalline ceramic particles described herein include any such fluids that can be mixed with the previously mentioned water based fluids. Specific water based polymer and polymer-containing treatment fluids for use with the present invention include guar and guar derivatives such as hydroxypropyl guar (HPG), carboxymethylhydroxypropyl guar (CMHPG), carboxymethyl guar (CMG), hydroxyethyl cellulose (HEC), carboxymethylhydroxyethyl cellulose (CMHEC), carboxymethyl cellulose (CMC), starch based polymers, xanthan based polymers, and biopolymers such as gum Arabic, carrageenan, and the like, as well as any combination of the above-mentioned fluids.

Exemplary non-aqueous treatment fluids that can be used include alcohols such as methanol, ethanol, isopropanol, and other branched and linear alkyl alcohols; diesel; raw crude oils; condensates of raw crude oils; refined hydrocarbons such as gasoline, naphthalenes, xylenes, toluene and toluene derivatives, hexanes, pentanes, and ligroin; natural gas liquids, gases such as carbon dioxide and nitrogen gas, and combinations of any of the above-described non-aqueous treatment fluids. Alternatively, mixtures of the above non-aqueous fluids with water are also envisioned to be suitable for use with the crystalline ceramic particles described herein, such as mixtures of water and alcohol or several alcohols. Mixtures can be made of miscible or immiscible fluids.

Crystalline ceramic particles described herein are mixed with a carrier fluid and introduced into a well having side wall fractures which are desired to be propped open to enhance transmission of subject fluids therethrough.

The carrier fluid carries crystalline ceramic particles described herein into the fractures where the particles are deposited. If desired, crystalline ceramic particles described herein might be color coded and injected in desired sequence such that during transmission of subject fluid therethrough, the extracted fluid can be monitored for presence of the crystalline ceramic particles. The presence and quantity of different colored proppant particles might be used as an indicator of what portion of the fractures are involved as well as indicate or presage possible changes in transmission properties.

Crystalline ceramic particles described herein can be used in wells to enhance extraction of desired fluids (i.e., subject fluids, such as oil, natural gas, or water, from naturally occurring or man-made reservoirs). Crystalline ceramic particles described herein may also be used in wells to enhance injection of desired fluids into naturally occurring or man-made reservoirs.

In some embodiments, the crystalline ceramic particles described herein are at least 100 micrometers (in some embodiments, at least 200, 300, 400, 500, 600, 700, 800, 900, 1000, 1100, 1200, 1300, 1400, 1500, 1600, 1700, 1800, 1900, 2000, 2500, or even at least 3000 micrometers; in some embodiments, in a range from 500 micrometers to 1700 micrometers) in size. In some embodiments, the treated particles have particle sizes in a range from 100 micrometers to 3000 micrometers (i.e., about 140 mesh to about 5 mesh) (in some embodiments, in a range from 1000 micrometers to 3000 micrometers, 1000 micrometers to 2000 micrometers, 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 to about 20 mesh), 300 micrometers to 600 micrometers (i.e., about 50 mesh to about 30 mesh), 250 micrometers to 425 micrometers (i.e., about 60 mesh to about 40 mesh), 200 micrometers to 425 micrometers (i.e., about 70 mesh to about 40 mesh), or 100 micrometers to 200 micrometers (i.e., about 140 mesh to about 70 mesh). In some embodiments, the treated particles are included with a plurality of other particles (i.e., a plurality of particles comprising the treated particles). In some embodiments, these particles collectively have particles in a range from 100 micrometers to 3000 micrometers (i.e., about 140 mesh to about 5 mesh) (in some embodiments, in a range from 1000 micrometers to 3000 micrometers, 1000 micrometers to 2000 micrometers, 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 to about 20 mesh), 300 micrometers to 600 micrometers (i.e., about 50 mesh to about 30 mesh), 250 micrometers to 425 micrometers (i.e., about 60 mesh to about 40 mesh), 200 micrometers to 425 micrometers (i.e., about 70 mesh to about 40 mesh), or 100 micrometers to 200 micrometers (i.e., about 140 mesh to about 70 mesh). In some embodiments, the “collective” plurality of particles comprises at least 5, 10, 15, 20, 25, 30, 35, 40, 45, 50, 55, 60, 65, 70, 75, 80, 85, 90, 95, 96, 97, 98, 99, or even at least 100 percent by weight of the treated particles.

Optionally, conventional proppant materials can also be used together with the crystalline ceramic particles described herein.

### Exemplary Embodiments

1. A crystalline ceramic particle comprising at least 90 percent by weight Al₂O₃, based on the total weight of the crystalline ceramic particle, and having a density in a range from 50 to 75 percent of theoretical density, a Long Term Flow Conductivity of at least 4.5×10⁻¹² m²-m at 55.2 MPa, and a smallest dimension of at least 100 micrometers.

2. The crystalline ceramic particle of embodiment 1, comprising at least 92 percent by weight of the Al₂O₃, based on the total weight of the crystalline ceramic particle.

3. The crystalline ceramic particle of embodiment 1, comprising at least 93 percent by weight of the Al₂O₃, based on the total weight of the crystalline ceramic particle.

4. The crystalline ceramic particle of embodiment 1, comprising at least 94 percent by weight the Al₂O₃, based on the total weight of the crystalline ceramic particle.

5. The crystalline ceramic particle of embodiment 1, comprising at least 95 percent by weight of the Al₂O₃, based on the total weight of the crystalline ceramic particle.

6. The crystalline ceramic particle of embodiment 1, comprising at least 96 percent by weight of the Al₂O₃, based on the total weight of the crystalline ceramic particle.

7. The crystalline ceramic particle of embodiment 1, comprising at least 97 percent by weight of the Al₂O₃, based on the total weight of the crystalline ceramic particle.

8. The crystalline ceramic particle of embodiment 1, comprising at least 98 percent by weight of the Al₂O₃, based on the total weight of the crystalline ceramic particle.

9. The crystalline ceramic particle of embodiment 1, comprising at least 99 percent by weight of the Al₂O₃, based on the total weight of the crystalline ceramic particle.

10. The crystalline ceramic particle of embodiment 1, comprising in a range from 90 to 99 percent by weight of the Al₂O₃, based on the total weight of the crystalline ceramic particle.

11. The crystalline ceramic particle of embodiment 1, comprising in a range from 94 to 99 percent by weight of the Al₂O₃, based on the total weight of the crystalline ceramic particle.

12. The crystalline ceramic particle of any preceding embodiment, wherein the density is in a range from 50 to 68 percent of theoretical density.

13. The crystalline ceramic particle of any preceding embodiment, wherein the Long Term Flow Conductivity is at least 4.5×10⁻¹² m²-m at 55.2 MPa.

14. The crystalline ceramic particle of any preceding embodiment, wherein the Long Term Flow Conductivity is in a range from 4.5×10⁻¹² m²-m to 6×10⁻¹² m²-m at 55.2 MPa.

15. The crystalline ceramic particle of any preceding embodiment, wherein the smallest dimension of at least 100 micrometers.

16. The crystalline ceramic particle of any preceding embodiment, wherein the smallest dimension is in a range from 100 micrometers to 3000 micrometers.

17. The crystalline ceramic particle of any preceding embodiment, wherein the Krumbein-Sloss Sphericity Number is in a range from 0.8 to 1.

18. The crystalline ceramic particle of any of embodiments 1 to 16, wherein the Krumbein-Sloss Sphericity Number is in a range from 0.85 to 1.

19. The crystalline ceramic particle of any of embodiments 1 to 16, wherein the Krumbein-Sloss Sphericity Number is in a range from 0.9 to 1.

20. The crystalline ceramic particle of any of embodiments 1 to 16, wherein the Krumbein-Sloss Sphericity Number is in a range from 0.95 to 1.

21. The crystalline ceramic particle of any preceding embodiment, wherein the Krumbein-Sloss Roundness Number is in a range from 0.8 to 1.

22. The crystalline ceramic particle of any of embodiments 1 to 20, wherein the Krumbein-Sloss Roundness Number is in a range from 0.85 to 1.

23. The crystalline ceramic particle of any of embodiments 1 to 20, wherein the Krumbein-Sloss Roundness is in a range from 0.9 to 1.

24. The crystalline ceramic particle of any of embodiments 1 to 20, wherein the Krumbein-Sloss Roundness is in a range from 0.95 to 1.

25. The spherical crystalline ceramic particle of preceding embodiment, further comprising at least one of rare earth oxide or Y₂O₃.

26. The spherical crystalline ceramic particle of embodiments 1 to 24 comprising in the range from 1 to 10 percent by weight of rare earth oxide, based on the total weight of the crystalline ceramic particle.

27. The spherical crystalline ceramic particle of embodiments 1 to 24 comprising in the range from 1 to 10 percent by weight of Y₂O₃, based on the total weight of the crystalline ceramic particle.

28. The spherical crystalline ceramic particle of embodiments 1 to 24 comprising in the range from 1 to 10 percent by weight collectively of rare earth oxide and Y₂O₃, based on the total weight of the crystalline ceramic particle.

29. The spherical crystalline ceramic particle of any preceding embodiment further comprising MgO.

30. The spherical crystalline ceramic particle of any of embodiments 1 to 22 comprising at least one rare earth aluminate exhibiting a magnetoplumbite crystal structure.

31. The spherical crystalline ceramic particle of preceding embodiment having an inner region and an outer region, wherein the outer region has a higher density than the inner region.

32. The spherical crystalline ceramic particle of preceding embodiment having a Crush Strength Value of at least 86 MPa.

33. The spherical crystalline ceramic particle of preceding embodiment having an Acid Solubility Loss of no greater than 2 percent by weight.

34. The spherical crystalline ceramic particle of any of embodiments 1 to 32 having an Acid Solubility Loss of no greater than 1 percent by weight.

35. The spherical crystalline ceramic particle of any of embodiments 1 to 32 having an Acid Solubility Loss of no greater than 1.5 percent by weight.

36. The spherical crystalline ceramic particle of any of embodiments 1 to 32 having an Acid Solubility Loss of no greater than 0.5 percent by weight.

37. The spherical crystalline ceramic particle of any preceding embodiment having a coating thereon.

38. The spherical crystalline ceramic particle of any preceding embodiment having a resin coating thereon.

39. The spherical crystalline ceramic particle of any of embodiments 37 or 38, wherein the coating includes glass bubbles.

40. A plurality of the spherical crystalline ceramic particles of any preceding embodiment.

41. The plurality of the spherical crystalline ceramic particles of embodiment 40, wherein at least 90 percent by volume have a smallest dimension of at least 100 micrometers.

42. The plurality of the spherical crystalline ceramic particles of any of embodiments 40 or 41, wherein at least 90 percent by volume of the spherical crystalline ceramic particles having an average diameter within 15% of the median diameter of the spherical crystalline ceramic particles.

43. The plurality of the spherical crystalline ceramic particles of any of embodiments 40 or 41, wherein at least 90 percent by volume of the spherical crystalline ceramic particles having an average diameter within 10% of the median diameter of the spherical crystalline ceramic particles.

44. A method of propping open fractures in the walls of a bored well, comprising:

introducing into the well a fluid mixture of carrier fluid and the plurality of spherical crystalline ceramic particles of any of embodiments 40 or 41; and depositing a plurality of the spherical crystalline ceramic particles in the fractures to yield at least one propped channel.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example

Four batches of an embodiment of proppant described herein were prepared as followed (i.e., the following was repeated four times). A nitrate solution was prepared by mixing lanthanum, yttrium, magnesium, cobalt nitrate solutions (obtained from Molycorp, Lourviers, Colo.) to together with water (about 14.5% La(NO₃)₃.6H₂O, about 9.25% Y(NO₃)₃.6H₂O, about 17.3% Mg(NO₃)₂.6H₂O, about 0.4% Co(NO₃)₂.6H₂O, and the balance deionized water).

400 grams of alumina spheres having continuous porosity of about 80 percent by volume (obtained from Sasol, Germany (1.8 mm in diameter; 1.8/210, product code 604130) were placed into a glass dish (150 mm in diameter, 75 mm in height; obtained under the trade designation “PYREX”). The nitrate solution was added such that the liquid surface was above the alumina spheres, allowing each sphere to be saturated with solution. The glass dish was placed into a sealed chamber and the air in the chamber evacuated to a pressure of 20 mm Hg. The beads and solution were allowed to sit in the chamber for 15 minutes, allowing the solution to infiltrate the alumina spheres. The vacuum to the chamber was released and the glass dish removed. The remaining nitrate solution (i.e., that which was not absorbed into the alumina spheres) was decanted from the glass dish. The alumina spheres (infiltrated with nitrate solution) were dried in an oven set at 95° C. for 4 hours.

The dried beads were calcined through a rotary kiln at 650° C., with an incline of 3 inches (7.6 cm metric) and a rotation of 4.2 revolutions/minute. The calcined beads were then sintered through a rotary kiln at 1400° C., with an incline of 8.25 inches (21 cm) and a rotation of 5 revolutions/minute.

The four batches of sintered alumina spheres were combined and sent to Stim-Lab, Inc, Duncan, Okla., for measurement of the following properties Long Term Flow Conductivity, Permeability, Crush Strength Value, and Acid Solubility Loss.

### Long Term Flow Conductivity and Permeability

Long Term Flow Conductivity and Permeability were measure at packing of 2 lb/ft² (9.8 kg/m²) and at 2,000, 4,000, 6,000, 8,000, and 10,000 psi (13.8, 27.6, 41.4, 55.2, and 69 MPa, respectively) closure stresses at 250° F. (121° C.) for 50 hours each on Ohio Sandstone (obtained from Walker Bros. Stone Co., McDermott, Ohio) as follows:
The equipment used for the measurement of Long Term Flow Conductivity and (liquid) Permeability included:
   a. 75 ton press (obtained from Dake Press Company, Grand Haven, Mich.) with air oil intensifier and flow cells with 10 in² (64.5 cm²) flow paths (obtained from Stim-Lab, Inc, Duncan, Okla., as “API SS316”).
   b. 40:1 pressure transducers (obtained under the trade designation “SMART FAMILY” from Rosemout, Chanhassen, Minn.) for measuring pressure drop and rate plumbed with 0.25 inch (0.635 cm) lines and calibrated with a computer (utilizing associated software obtained under the trade designation “SMART FAMILY” from Rosemout) and set at the 0-5 inch (1.25 cm) of water span range.
   c. Two gallon (3.8 liters) nitrogen driven fluid reservoirs filled with 2% KCl and deoxygenated with nitrogen.
   d. Internal gauges and calipers for measuring widths.
   e. A personal computer to process data and calculate Long Term Flow Conductivity and Permeability.
   f. Two 10 in² (64.5 cm²) of the Ohio Sandstone.

A flow cell (“API SS316”) was loaded with proppant sample to be tested. The proppant was leveled with a blade device. The proppant sample was placed between the core slabs of Ohio Sandstone and made a part of a four-cell stack. The cells were stacked to within 0.002 inch (0.05 mm) from top to bottom, and positioned between the platens of the press (Dake Press). Pressure was increased to 500 psi (3.45 MPa), and the system evacuated and saturated with water at 70-75° F. (21-24° C.). Once saturated, the closure pressure was increased to 1,000 psi (6.9 MPa) at a rate of 100 psi/min (0.69 MPa). The proppant was allowed to equilibrate as outlined in the data tables, shown in Table 1, below. The flow rate, pressure differential, and average width were measured at each pressure in order to calculate Long Term Flow Conductivity and Permeability.

Five measurements were taken and averaged to arrive at each Long Term Flow Conductivity. Flow rate was measured with a flow meter (obtained under the trade designation “LIQUIFLOW” from Bronkhorst USA, Bethlehem, Pa.), which was calibrated with an analytical balance (obtained under the trade designation “METTLER” from Mettler Toledo, Columbus, Ohio) to 0.01 ml/min. Darcy's Law was used for the calculations to determine the Long Term Flow Conductivity and Permeability. The test temperature was increased to 250° F. (121° C.) and allowed to equilibrate. The temperature was left at 250° F. (121° C.) for 12 hours prior to increasing the closure pressure.

The Long Term Flow Conductivity and Permeability of the proppant were collected at 1,000 psi (6.9 MPa) at both room temperature (about 75° F. (about 24° C.)) and 250° F. (121° C.). The pressure was increased at 100 psi (0.69 MPa) per minute at 1,000 psi (6.9 MPa) increments and the above measuring technique repeated. The Long Term Flow Conductivity and Permeability of the proppant were continuously monitored at 2,000 psi (13.8 MPa) and 250° F. (121° C.) for 50 hours. The pressure was increased and the Long Term Flow Conductivity and Permeability of the proppant were continuously monitored at 4,000 psi (27.6 MPa) and 250° F. (121° C.) for 50 hours. The pressure was increased and the Long Term Flow Conductivity and Permeability of the proppant were continuously monitored at 6,000 psi (41.4 MPa) and 250° F. (121° C.) for 50 hours. The pressure was increased and the Long Term Flow Conductivity and Permeability of the proppant were continuously monitored at 8,000 psi (55.2 MPa) and 250° F. (121° C.) for 20 hours. The pressure was increased and the Long Term Flow Conductivity and Permeability of the proppant were continuously monitored at 10,000 psi (69 MPa) and 250° F. (121° C.) for 50 hours.

The results of the Long Term Flow Conductivity and Permeability are shown in Table 1, below.

TABLE 1

| Hours at | | | | | | | | | | |
|---|---|---|---|---|---|---|---|---|---|---|
| Closure & | Closure | | Temperature | | Conductivity | | Width | | Permeability | |
| Temperature | (psi) | MPa | ° F. | ° C. | md-ft | m²-m | in | mm | Darcy | m² |
| −14 | 1000 | 6.9 | 75 | 24 | 45644 | 1.37E−11 | 0.254 | 6.4516 | 2156 | 2.13E−09 |
| 2 | 1000 | 6.9 | 250 | 121 | 44991 | 1.35E−11 | 0.257 | 6.5278 | 2101 | 2.07E−09 |
| 0 | 2000 | 13.8 | 250 | 121 | 38852 | 1.17E−11 | 0.253 | 6.4262 | 1843 | 1.82E−09 |
| 10 | 2000 | 13.8 | 250 | 121 | 37778 | 1.14E−11 | 0.252 | 6.4008 | 1799 | 1.78E−09 |
| 20 | 2000 | 13.8 | 250 | 121 | 37196 | 1.12E−11 | 0.252 | 6.4008 | 1771 | 1.75E−09 |
| 30 | 2000 | 13.8 | 250 | 121 | 36969 | 1.11E−11 | 0.252 | 6.4008 | 1760 | 1.74E−09 |
| 40 | 2000 | 13.8 | 250 | 121 | 36836 | 1.11E−11 | 0.252 | 6.4008 | 1754 | 1.73E−09 |
| 50 | 2000 | 13.8 | 250 | 121 | 36751 | 1.11E−11 | 0.252 | 6.4008 | 1750 | 1.73E−09 |
| 0 | 4000 | 27.6 | 250 | 121 | 33970 | 1.02E−11 | 0.245 | 6.223 | 1664 | 1.64E−09 |
| 10 | 4000 | 27.6 | 250 | 121 | 33008 | 9.93E−12 | 0.244 | 6.1976 | 1623 | 1.60E−09 |
| 20 | 4000 | 27.6 | 250 | 121 | 32773 | 9.86E−12 | 0.244 | 6.1976 | 1612 | 1.59E−09 |
| 30 | 4000 | 27.6 | 250 | 121 | 32541 | 9.79E−12 | 0.244 | 6.1976 | 1600 | 1.58E−09 |
| 40 | 4000 | 27.6 | 250 | 121 | 32498 | 9.78E−12 | 0.244 | 6.1976 | 1598 | 1.58E−09 |
| 50 | 4000 | 27.6 | 250 | 121 | 32461 | 9.76E−12 | 0.244 | 6.1976 | 1596 | 1.58E−09 |
| 0 | 6000 | 41.4 | 250 | 121 | 29380 | 8.84E−12 | 0.24 | 6.096 | 1469 | 1.45E−09 |
| 10 | 6000 | 41.4 | 250 | 121 | 25913 | 7.79E−12 | 0.238 | 6.0452 | 1307 | 1.29E−09 |
| 20 | 6000 | 41.4 | 250 | 121 | 25160 | 7.57E−12 | 0.236 | 5.9944 | 1279 | 1.26E−09 |
| 30 | 6000 | 41.4 | 250 | 121 | 24691 | 7.43E−12 | 0.236 | 5.9944 | 1256 | 1.24E−09 |
| 40 | 6000 | 41.4 | 250 | 121 | 24601 | 7.40E−12 | 0.236 | 5.9944 | 1251 | 1.23E−09 |
| 50 | 6000 | 41.4 | 250 | 121 | 24552 | 7.39E−12 | 0.236 | 5.9944 | 1248 | 1.23E−09 |
| 0 | 8000 | 55.2 | 250 | 121 | 22122 | 6.65E−12 | 0.232 | 5.8928 | 1144 | 1.13E−09 |
| 10 | 8000 | 55.2 | 250 | 121 | 20790 | 6.25E−12 | 0.23 | 5.842 | 1085 | 1.07E−09 |
| 20 | 8000 | 55.2 | 250 | 121 | 19028 | 5.72E−12 | 0.229 | 5.8166 | 997 | 9.84E−10 |
| 30 | 8000 | 55.2 | 250 | 121 | 18716 | 5.63E−12 | 0.229 | 5.8166 | 981 | 9.68E−10 |
| 40 | 8000 | 55.2 | 250 | 121 | 18610 | 5.60E−12 | 0.229 | 5.8166 | 975 | 9.62E−10 |
| 50 | 8000 | 55.2 | 250 | 121 | 18553 | 5.58E−12 | 0.229 | 5.8166 | 972 | 9.59E−10 |
| 0 | 10000 | 68.9 | 250 | 121 | 14865 | 4.47E−12 | 0.223 | 5.6642 | 800 | 7.90E−10 |
| 10 | 10000 | 68.9 | 250 | 121 | 11653 | 3.51E−12 | 0.218 | 5.5372 | 641 | 6.33E−10 |
| 20 | 10000 | 68.9 | 250 | 121 | 10985 | 3.30E−12 | 0.217 | 5.5118 | 608 | 6.00E−10 |
| 30 | 10000 | 68.9 | 250 | 121 | 10759 | 3.24E−12 | 0.216 | 5.4864 | 598 | 5.90E−10 |
| 40 | 10000 | 68.9 | 250 | 121 | 10667 | 3.21E−12 | 0.216 | 5.4864 | 593 | 5.85E−10 |
| 50 | 10000 | 68.9 | 250 | 121 | 10619 | 3.19E−12 | 0.216 | 5.4864 | 590 | 5.82E−10 |

### Crush Strength Value

The Crush Strength Value of the sintered alumina spheres was tested following the standard, ARI RP 60, Second Edition, December 1995, Section 8, entitled “Recommended Proppant Crush Resistance Test,” the disclosure of which is incorporated herein by reference. The sintered alumina spheres were about 1.25 mm in diameter, which corresponds to a 12/20 mesh size (i.e., the size that falls between a 12 mesh screen (1.7 mm opening) and a 20 mesh screen (0.85 mm opening)).

The bulk density of the sintered alumina spheres was determined as set out in the standard, ARI RP 60, Second Edition, December 1995, Section 9, entitled “Recommended Procedures for Determining Proppant Bulk Density, Apparent Density, and Absolute Density,” the disclosure of which is incorporated herein by reference. The weight of a dry 100-milliliter volumetric flask was determined and recorded. A funnel was placed in the neck of the volumetric flask and filled it with proppant to the 100 milliliter mark. The filled flask was weighed and recorded. The proppant bulk density was determined using the equation below.

ρ_{b}=(W_{f.p.}−W_{f})/(100)

Where:
ρ_{b}=Proppant bulk density, g/cm³
W_{f.p.}=Weight of flask and proppant, g
W_{f}=Weight of flask, g

The bulk density of the sintered alumina spheres was determined to be 1.56 g/cm³.

A test cell shown in FIG. 6 (Example Test Cell for Proppant Crush Resistance Test) of ARI RP 60, Second Edition, December 1995, entitled “Recommended Practices for Testing High-Strength Proppants Used in Hydraulic Fracturing Operations,” the disclosure of which is incorporated herein by reference, was used to determine Crush Strength Values. A proppant sample charge of 38.6 grams was placed into the test cell. The test cell was placed into a press and a set load of 10,000 psi (68.95 MPa) was applied to the cell. The load was applied at a uniform loading rate to attain 10,000 psi (68.95 MPa), taking 1 minute to reach the desired load. The set load was maintained for two minutes and then reduced to zero. The proppant charge was recovered from the test celled and screened through 12 (Tyler) mesh and 20 (Tyler) mesh screens. The weight of the fines (material passing through 20 (Tyler) mesh screen) was recorded. The proppant Crush Strength Value was determined using the equation below.

CS=(100*W_{f})/(Wₚ)

Where:
CS=Crush Strength Value, % fines
W_{f}=Weight of Fines
Wₚ=Weight of initial proppant charge, g

The Crush Strength Value test was repeated two additional times at a load of 10,000 psi (68.95 MPa) and three additional times at a load of 12,500 psi (86.2 MPa). The mean values of the analyses are reported in Table 2, below.

TABLE 2

Pressure

| psi | MPa | Fines % |
|---|---|---|
| 10,000 | 68.95 | 6.0 |
| 12,500 | 86.18 | 9.6 |

### Acid Solubility Loss

The Acid Solubility Loss of the sintered alumina spheres were evaluated of the standard, API RP 56, Second edition, December 1995, Section 7, entitled “Evaluation of Sand Solubility in Acid,” the disclosure of which is incorporated herein by reference. A 1000 milliliter solution of 12 molar HCl-3 molar HF acid was prepared using hydrofluoric acid (HF). 500 milliliters of distilled water was added to a 1000 milliliter polyethylene graduated cylinder. A charge of 54 milliliters of 52% hydrofluoric acid (HF) was added to the water in the graduated cylinder. A charge of 293 milliliters of 37% hydrochloric acid (HCl) was added to the water-acid solution. Distilled water was added to bring the total acid-water mixture to 1000 milliliters.

The fired alumina spheres were dried in an oven at 105° C. and cooled in a desiccator. A sample charge of 5 grams of fired alumina spheres was added to a 150 milliliter polyethylene beaker along with 100 milliliters of the 12 molar HCl-3 molar HF acid solution. The beaker was placed in a water bath held at 65.6° C. for 30 minutes.

A filtering apparatus was set-up by adding a #42 filter paper (obtained under the trade designation “WHATMAN” from VWR Scientific) to a filter funnel The filtering apparatus was weighed and recorded. The sintered alumina spheres and acid solution was added and filtered through the filter apparatus. The filter was washed three times with a 20 milliliter solution of distilled water. The filter apparatus and retained sintered alumina spheres were dried in an oven at 105° C. for an hour. The dried apparatus and retained sample was weighed and recorded. The percent sand solubility was determined using the following equation.

S=[(Wₛ+W_{f}−W_{fs})/(Wₛ)]×(100)

Where:
S=Sand solubility, weight percent
Wₛ=Weight of sintered alumina spheres, g
W_{f}=Weight of filter, g
W_{fs}=Weight of dried filter and sintered alumina spheres, g

The above evaluation was repeated two more times. The mean value of the three evaluations was 0%.

### Comparative Example

The Crush Strength Value of the as-received alumina spheres was tested following the procedure set out in the Example above. The as-received alumina spheres were about 1.8 mm in diameter. The bulk density of the as-received alumina spheres was determined following the procedure set out in the Example above. The bulk density of the sintered alumina spheres was determined to be 0.56 g/cm³.

A proppant sample charge of 13.8 grams was placed into the test cell. The test cell was placed into a press and a set load of 8,000 psi (55.2 MPa) was applied to the cell. The load was applied at a uniform loading rate to attain 8,000 psi (55.2 MPa), taking 1 minute to reach the desired load. The set load was maintained for two minutes and then reduced to zero. The proppant charge was recovered from the test celled and screened through 10 (Tyler) mesh (2000 micrometer opening) and 18 (Tyler) (1000 micrometer opening) mesh screens. The weight of the fines (material passing through 18 (Tyler) mesh screen) was recorded. The procedure was repeated two more times and the mean value of the crush strength was determined to be 64.3%.

The crush strength value for the as-received alumina spheres shows a large amount of fines were produced at a stress level of 8,000 psi (55.2 MPa). This suggests a lower long-term conductivity value for the as-received alumina spheres verses the sintered alumina spheres. Although not wanting to be bound by theory, it is believed that long-term conductivity is related to the open space within the proppant pack and the width of the proppant pack. Less open space and lower pack width causes a reduction in flow and results in a lower long-term conductivity value. The increased fines produced in the as-received sample would fill the interstitial spaces between the spheres and decrease the open space for flow to occur. It would also result in a decrease in proppant pack width. Both results would have an effect of reducing the total flow through the pack, and thus a lower long-term conductivity.

Foreseeable modifications and alterations of this invention will be apparent to those skilled in the art without departing from the scope and spirit of this invention. This invention should not be restricted to the embodiments that are set forth in this application for illustrative purposes.

1. A crystalline ceramic particle comprising greater than 90 percent by weight Al₂O₃, based on the total weight of the crystalline ceramic particle, and having a density in a range from 50 to 75 percent of theoretical density, and a Long Term Flow Conductivity of at least 4.5×10⁻¹² m²-m at 55.2 MPa.

2. The crystalline ceramic particle of claim 1, comprising in a range from 91 to 99 percent by weight of the Al₂O₃, based on the total weight of the crystalline ceramic particle.

3. The crystalline ceramic particle of claim 1, wherein the density is in a range from 50 to 68 percent of theoretical density.

4. (canceled)

5. The crystalline ceramic particle of claim 1, wherein the Long Term Flow Conductivity is in a range from 4.5×10⁻¹² m²-m to 6×10⁻¹² m²-m at 55.2 MPa.

6. The crystalline ceramic particle of claim 1, wherein the smallest dimension is of at least 100 micrometers.

7. The crystalline ceramic particle of claim 1, wherein the Krumbein-Sloss Sphericity Number is in a range from 0.8 to 1.

8. (canceled)

9. The spherical crystalline ceramic particle of claim 1, further comprising at least one of rare earth oxide or Y₂O₃.

10. A method of propping open fractures in the walls of a bored well, comprising:
introducing into the well a fluid mixture of carrier fluid and a plurality of spherical crystalline ceramic particles of any preceding claim; and
depositing a plurality of the spherical crystalline ceramic particles in the fractures to yield at least one propped channel.

11. A crystalline ceramic particle comprising greater than 90% percent by weight Al₂O₃ based on the total weight of the crystalline ceramic particle, and at least one metal oxide selected from the group consisting of MgO, Y₂O₃, ZrO₂, SiO₂, TiO₂, CeO₂, and rare earth oxide.

12. A crystalline ceramic particle according to claim 11 having a specific density in a range from 50 to 75 percent of the theoretical density of the particle.

13. A crystalline ceramic particle according to claim 11 comprising the metal oxide in a range from 0.1 to 9.9% percent by weight of the crystalline ceramic particle.

14. A crystalline ceramic particle according to claim 11 further having a density in a range from 50 to 75 percent of theoretical density, and a Long Term Flow Conductivity of at least 4.5×10⁻¹² m²-m at 55.2 MPa.
